(19) United States
(12) Patent Application Publication
(10) Pub. No.: US 2012/0189937 A1
(43) Pub. Date: Jul. 26, 2012

(54) HIGH-TEMPERATURE POLYMER ELECTROLYTE FUEL CELL SYSTEM (HT-PEFC) AND A METHOD FOR OPERATING THE SAME

(76) Inventors: Hendrik Dohle, Eschweiler (DE); Hans-Friedrich Oetjen, Linnich (DE); Birgit Schumacher, Juelich (DE)

(21) Appl. No.: 12/735,429

(22) PCT Filed: Jan. 15, 2009
(86) PCT No.: PCT/DE09/00041

§ 371 Date: Aug. 18, 2010

(30) Foreign Application Priority Data
Jan. 24, 2008 (DE) 10 2008 005 841.6

(51) Int. Cl. H01M 8/24; G01N 7/00; H01M 8/04

(52) U.S. Cl. 429/456; 429/465; 73/23.2

(57) ABSTRACT

A high-temperature polymer electrolyte membrane fuel cell stack has at least two high-temperature polymer electrolyte membrane fuel cells (HT-PEFC), which comprise at least one means for determining the CO₂ concentration of the cathode waste gas. A method for checking this fuel cell stack is thus possible, wherein at least the CO₂ concentration of the cathode waste gas is determined. Optionally, the CO₂ concentration of the oxidizing agent that is supplied can also be determined. The CO₂ concentration is advantageously conducted in the region of individual cells or cell sections. This can be done, for example, by way of a displaceable lance in the cathode waste gas channel or a plurality of outlets (valves) in the cathode waste gas channel. If a threshold value defining the normal state of functional individual cells is exceeded, appropriate measures can be initiated, such as switching off the entire stack and optionally replacing cells or cell blocks. For more precise information, according to the invention the CO₂ concentration of the cathode waste gas is determined not only overall, but also at the outlets of individual cells or cell sections within the manifold.

The invention relates to a fuel cell system and to a method for operating this fuel cell system, and in particular relates to a method for monitoring a high-temperature polymer electrolyte fuel cell (HT-PEFC) system.

### STATE OF THE ART

Fuel cells are sources of electric power, in which chemical energy is converted into electric energy by the electrochemical oxidation of an easily oxidizable substance, typically hydrogen with oxygen. Due to the low voltage that an individual fuel cell supplies, generally a large number of fuel cells are interconnected in a larger fuel cell device (fuel cell stack).

The fuel cell in each case comprises an electrolyte, such as an ion exchanger membrane, a gas diffusion layer each for the anode and for the cathode, and gas distribution channels, which are provided at the anode and/or cathode. In recent times, significant progress has been made with respect to the polymer electrolyte membrane (PEM) fuel cells. These cells require hydrogen to operate. Storing hydrogen requires handling either compressed or cryogenic liquefied gases. The polymer electrolyte membrane fuel cell (PEFC) is generally extremely sensitive to carbon monoxide (CO), which develops together with the hydrogen during the reformation processes. As a result, both reformation processes must be connected to a gas treatment unit which removes the CO.

The polymer electrolyte fuel cell is a low-temperature fuel cell. For operating temperatures up to 100° C., solid polymer membranes are usually used, such as those made of Nafion. Nafion membranes, however, are not usually suitable at higher operating temperatures that reach up to approximately 200° C., because at these temperatures they do not have sufficient moisture, and thus the conductivity of the membranes decrease significantly. In addition, they are thermally unstable at temperatures above 150° C.

Instead, in these temperature ranges, membranes made of polyimide, and for example, polybenzimidazole (PBI), are used, on which phosphoric acid or sulfuric acid is bound as the electrolyte. These materials do not require high relative humidity in the reaction gases, which eliminates the need for water management.

PBI membranes enable a new generation of polymer electrolyte fuel cells, which are generally more cost-effective, more efficient, and more reliable than conventional low-temperature fuel cell systems. In addition, they employ a simplified gas treatment process marked by a high tolerance for carbon monoxide and sulfur. Furthermore, the operation of a high-temperature polymer electrolyte fuel cell (HT-PEFC) system is characterized by simple control.

HT-PEFC are based on PBI membranes saturated with phosphoric acid. However, due in part to the high content of phosphoric acid, the membranes are mechanically sensitive. During operation, these membranes are furthermore exposed to varying thermal and mechanical stresses. A major cause of malfunction of such a fuel cell is therefore the failure of the membrane.

According to the present state of the art, a failure of the membrane during operation can only be detected by a drop in the cell voltage. Such a case, however, already involves a major defect, because smaller defects usually do not result in a noticeable drop in the cell voltage. Major defects disadvantageously reduce the operational reliability of a stack because the hydrogen, which flows through in large volumes, reacts with the atmospheric oxygen and produces local temperature peaks. As a result, further consequential damage, such as the damage to the bipolar plates, is to be expected, requiring replacement not only of the defective membrane, but of the entire individual cell.

In addition, while safety-critical applications, such as aviation applications, necessitate the early detection of emerging defects, this is presently not possible with the prior art.

### PROBLEM AND SOLUTION

It is an object of the invention to create a method which can be used to reliably determine even emerging defects in the PBI membranes of a fuel cell, or of a fuel cell system. It is also an object of the invention to provide a fuel cell system with which this method can be carried out.

The objects of the invention are achieved by a method for monitoring a fuel cell system according to the main claim and by a fuel cell system according to the additional independent claim. Advantageous embodiments of the method and of the system will be apparent from the respective dependent claims.

### SUBJECT MATTER OF THE INVENTION

Since the invention relates to the interaction of a method with a suitable apparatus, hereinafter, the method and the fuel cell system will sometimes be described in parallel.

The invention is based on the idea that an HT-PEFC is usually operated with a reformer gas comprising CO and CO₂. When an initially small defect occurs in the membrane, these gas components pass over to the cathode, where the CO is oxidized into CO₂ due to the presence of the atmospheric oxygen and the catalyst. In the case of a membrane defect, the cathode waste gas thus contains an additional quantity of CO₂. According to the invention, this is captured by a means for determining a CO₂ concentration and is then optionally evaluated by control electronics.

If the CO₂ concentration in the cathode waste gas rises above the standard of approximately 300 ppm, this is an indication of emerging damage to the membrane. In this case, starting at a defined threshold value above the normal value, for example starting at 400 ppm or 500 ppm, suitable countermeasures can be taken, such as switching off the system and/or replacing individual cells. Above 2000 ppm, clear damage usually exists in the fuel cell system.

Thus, in the method according to the invention, at least one means (sensor) is used on the cathode side of an HT-PEFC, which is able to determine the CO₂ content of the cathode waste gas in the cathode waste gas collecting line (cathode outlet), or in the external cathode waste gas line. A suitable means could be, for example, an IR-based CO₂ sensor, which advantageously exhibits no cross-sensitivity to water, or a CO₂ sensor which usually responds to CO₂ with a fast pH value change.

In a first embodiment of the invention, the measurement position of the means for determining the CO₂ concentration may be located in the cathode waste gas line of the fuel cell stack.

In a further embodiment of the invention, the CO₂ fraction occurring naturally in the air, which is the oxidizing agent being supplied to the HT-PEFC, is taken into account. This fraction can fluctuate significantly, especially in the case of mobile systems, due to the influence of the surroundings. As a result, in this further embodiment, not only is the CO₂ concentration of the cathode waste gas measured, but the CO₂ concentration of the oxidizing agent that is supplied, such as the ambient air, is also measured by way of a further sensor. In a subsequent step, the difference between the two values is analyzed and used for assessing the damage.

Finally, the method and the apparatus can also be applied to high-temperature polymer electrolyte fuel cell systems operated with pure hydrogen. Because, in this case, no CO₂ that could pass through a defective membrane is usually present in the fuel gas, a defined CO₂ pulse is applied to the anode side in order to check the cell. For this purpose, the hydrogen in the anode chamber may be additionally supplied with CO₂ at certain time intervals by way of a CO₂ reservoir, such as a commercially available CO₂ cartridge, and the effect on the CO₂ concentration in the cathode waste gas can be measured as is described above. The CO₂ signal can then be correlated with the permeability and/or the functionality of the membrane.

In addition to the basic knowledge of the existence of such a defect inside the fuel cell stack, frequently knowledge of the more precise location of this defect in the stack is also of great interest, particularly when the stack comprises a large number of individual cells. In the following embodiment, the CO₂ concentration is therefore determined not only at a single measurement point, for example in the external cathode waste gas line, but rather at different locations in the internal cathode waste gas system, which is referred to as the manifold. In an advantageous embodiment of the invention, for this purpose, a CO₂ sensor is provided with a lance, which extends into the cathode manifold inside the stack, where it takes in air for measurement. The lance can be displaced inside the manifold in a targeted manner, so that individual measurements can be locally associated with the cathode waste gas of specific individual cells.

If the lance, for example, is located directly at the outlet of a defective cell, the highest CO₂ concentration will be recorded there. Those skilled in the art will thus be able to decide, on a case-by-case basis, whether a measurement is required for each individual cell, in order to check the stack, or whether a measurement is to be performed for a certain region, such as every 5 or 10 cells. The more differentiated the measurements are, the more precisely an individual defective cell can be detected.

In a further embodiment of the invention, the measurement of the CO₂ concentration is not carried out by using a displaceable lance, but the fuel cell stack itself comprises outlets on the manifold at certain intervals, such as in the form of valves, to which one or more CO₂ sensors can be directly connected.

### SPECIFIC DESCRIPTION

The invention will be described in more detail hereinafter based on figures, without thereby limiting the invention or the claimed subject matter. Shown are:

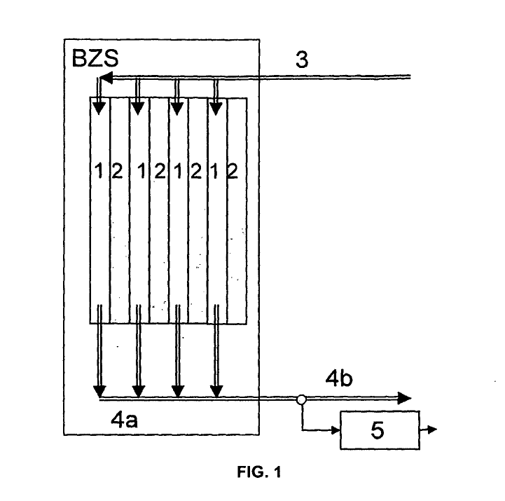

FIG. 1: an embodiment of the fuel cell system according to the invention, comprising a means for determining a CO₂ concentration in the cathode waste gas.

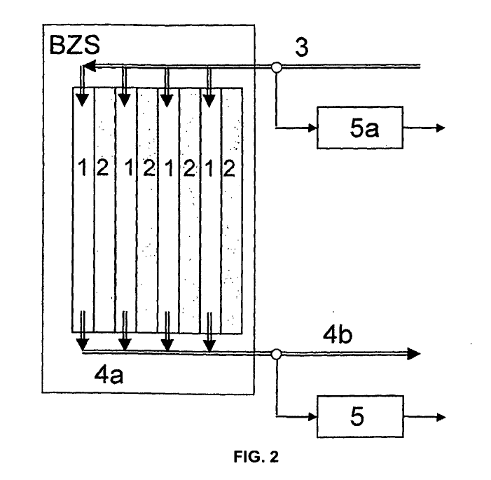

FIG. 2: an embodiment of the fuel cell system according to the invention, comprising a means for determining a CO₂ concentration in the cathode waste gas and, for reference, in the oxidizing agent.

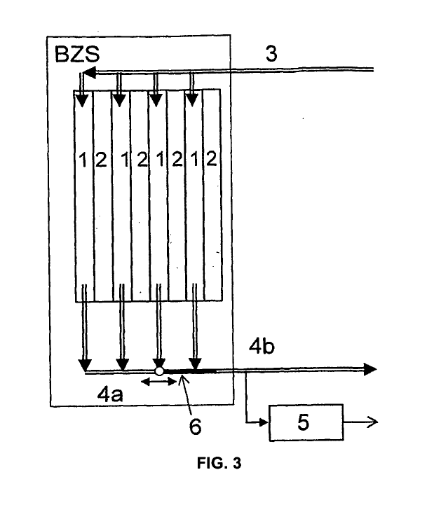

FIG. 3: an embodiment of the fuel cell system according to the invention, comprising a means having a displaceable lance for determining a CO₂ concentration at various points in the line of the manifold.

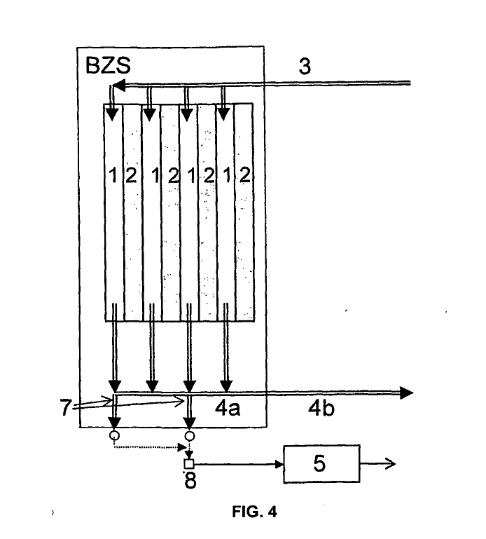

FIG. 4: an embodiment of the fuel cell stack according to the invention, comprising a means for determining a CO₂ concentration, wherein the cathode manifold itself comprises different outlets for measuring CO₂ at different points.

FIGS. 1 to 4 each show schematic illustrations of a fuel cell stack having individual cells which, in each case, comprise an anode having an anode chamber (2), a cathode having a cathode chamber (1), and an electrolyte disposed in between. A cathode supply line (3) leads to the individual cathode chambers (1). The cathode waste gas from the individual cells is initially collected in the internal cathode waste gas collecting line (4a) and is then removed from the fuel cell stack by way of the external cathode waste gas line (4b).

In the first embodiment, a means for determining a CO₂ concentration is disposed in the external cathode waste gas line (cathode outlet) (4b). The means as such may be disposed inside the line or in a branch line (bypass) of this line section. This is notably the case if only a small partial flow is required through the means in order to determine the CO₂ concentration, such as in the case of a CO₂ sensor.

During operation of the HT-PEFC with pure hydrogen, as an alternative, a defined CO₂ pulse can be applied to the operating means on the anode side in order to check the cells.

A further embodiment is shown in FIG. 2. Here, a first means (5) for determining the CO₂ concentration is disposed in the external cathode waste gas line (4b), and a further means (5a) is disposed in the oxidizing agent supply line (3) in order to measure the difference in the CO₂ contents. As a result of this arrangement, independence is advantageously achieved from the CO₂ concentration of the oxidizing agent that is supplied.

FIG. 3 shows an embodiment of the invention in a case where information about defective cells is not required for the entire overall stack, but rather detailed information about individual cells or cell sections is desired. Here, the means for determining CO₂ concentration comprises a displaceable lance for taking in gas, the lance being variably displaceable inside the cathode waste gas collecting line (manifold) in the inner part of the fuel cell stack. This offers the advantage that the lance can be displaced locally inside the manifold (4a) so that the intake of gas for determining the CO₂ concentration can take place at a location at which the cathode waste gas from an individual cell enters the manifold. In this way, direct information can be provided about the functionality of this individual cell by way of the measurement of the CO₂ concentration. In terms of the method for determining the CO₂ concentration, it remains up to the person skilled in the art whether the measurement is to be performed for each individual cell or in sections, for example, in order to be able to provide information about proper function over a certain cell range. If there is deviation, the cathode waste gas of the individual cells in this range can then be analyzed in more detail.

According to a further embodiment of the invention, which is illustrated in FIG. 4, instead of a variable lance, the cathode manifold (4a) of the fuel cell stack itself already provides several branching possibilities at certain intervals. This could be implemented, for example, by a multiway valve every 60 cells or, for increased accuracy, every 20 cells. In this way, it is possible to feed the cathode waste gas at these points to the means for determining the CO₂ concentration, so as to be able to obtain information about whether increased CO₂ concentrations are present in this cell section. When the CO₂ concentration of the cathode waste gas is determined in parallel or consecutively at the individual branching points, a comparison of these measurements allows one or more defective cells to be at least confined to a range, in this case approximately 60 cells (or for increased accuracy, approximately 20 cells) in a simple manner.

In a prototype, for example, a fuel cell system having 60 individual cells, each being 300 cm², was set up. The fuel cell stack was operated at T=180° C. and P=1 bar. The cathode was supplied with air at a maximum of 400 l/min by way of the cathode supply line. The CO₂ concentration in the air at the inlet was generally approximately 300 ppm. IR-based CO₂ sensors determined the CO₂ concentration, both in the oxidizing agent supply line and in the external cathode waste gas line. Defective cells exhibited detected CO₂ concentrations in the cathode waste gas of up to 1000 ppm.

1. A method for checking a high-temperature polymer electrolyte membrane fuel cell stack having at least two high-temperature polymer electrolyte membrane fuel cells (HT-PEFC), comprising determining at least the CO₂ concentration of the cathode waste gas.

2. The method according to claim 1, wherein at least one IR-based CO₂ sensor is used to determine the CO₂ concentration.

3. A method according to claim 1, wherein the CO₂ concentration in the external cathode waste gas line is determined.

4. A method according to claim 1, wherein the CO₂ concentration of the cathode waste gas is determined at least at one point inside the stack.

5. A method according to claim 1, wherein the CO₂ concentration of the cathode waste gas is determined within the stack.

6. A method according to claim 1, wherein the CO₂ concentration of the cathode waste gas is determined at least at two points within the stack.

7. A method according to claim 1, wherein a means for determining a CO₂ concentration is further disposed in the oxidizing agent supply line of the high-temperature polymer electrolyte membrane fuel cell stack.

8. A method according to claim 1, wherein a CO₂ pulse is applied to the anode side of the high-temperature polymer electrolyte membrane fuel cell stack, and subsequently the CO₂ concentration of the cathode waste gas is determined.

9. A high-temperature polymer electrolyte membrane fuel cell stack comprising at least two high-temperature polymer electrolyte membrane fuel cells (HT-PEFC), and at least one means for determining the CO₂ concentration of the cathode waste gas.

10. The high-temperature polymer electrolyte membrane fuel cell stack according to claim 9, comprising a CO₂ sensor as the means for determining the CO₂ concentration.

11. A high-temperature polymer electrolyte membrane fuel cell stack according to claim 9, wherein the means comprises a supply line to the external cathode waste gas line.

12. A high-temperature polymer electrolyte membrane fuel cell stack according to claim 9, wherein the means comprises a feed line to an internal cathode waste gas collecting line.

13. The high-temperature polymer electrolyte membrane fuel cell stack according to claim 11, wherein the means comprises a plurality of . supply lines to the internal cathode waste gas collecting line.

14. The high-temperature polymer electrolyte membrane fuel cell stack according to claim 11, wherein the supply line comprises a displaceable lance.

15. The high-temperature polymer electrolyte membrane fuel cell stack according to claim 9, comprising a further means for determining the CO₂ concentration in the cathode waste gas of the stack.

16. A high-temperature polymer electrolyte membrane fuel cell stack according to claim 9, comprising a further means for determining the CO₂ concentration in the oxidizing agent supply line of the stack.
